(19) United States
(12) Patent Application Publication
(10) Pub. No.: US 2023/0108171 A1
(43) Pub. Date: Apr. 6, 2023

(54) METHOD FOR IMPREGNATING, STRENGTHENING OR ELECTRICALLY INSULATING A BODY BEARING SINGLE-PLY OR MULTI-PLY WINDINGS

(71) Applicant: Siemens Aktiengesellschaft, 80333 München (DE)

(72) Inventors: KLAUS BÜTTNER, Hollstadt (DE); TOBIAS KATZENBERGER, Bad Königshofen, STT Unteressfeld (DE); KLAUS KIRCHNER, Ostheim (DE); BASTIAN PLOCHMANN, Neustadt an der Aisch (DE); MATTHIAS WARMUTH, Windshausen (DE)

(73) Assignee: Siemens Aktiengesellschaft, 80333 München (DE)

(21) Appl. No.: 17/801,983

(22) PCT Filed: Jan. 13, 2021
(86) PCT No.: PCT/EP2021/050569

§ 371 Date: Aug. 24, 2022

(30) Foreign Application Priority Data
Feb. 25, 2020 (EP) 20159310.0

(51) Int. Cl. H02K 15/12

(52) U.S. Cl. CPC H02K 15/12

(57) ABSTRACT

In a method for impregnating, strengthening or electrically insulating a body supporting single or multi-layer windings, in particular for an electric machine, the body supporting the windings is submerged into a multi-component resin system or is sprinkled with the multi-component resin system or is sprayed with the multi-component resin system.

The invention relates to a method for impregnating, strengthening or electrically insulating a body supporting single or multi-layer windings.

DE 10 2013 017 299 A1 relates to a method for impregnating, strengthening or electrically insulating a body supporting single or multi-layer windings, in particular for an electric motor/generator or transformer, wherein the body supporting the windings, under the influence of temperature, is submerged into a resin or a varnish or is sprinkled with resin or with varnish, wherein before and/or during and/or after the submerging or sprinkling the body and/or the windings supported by it are inductively heated in a locally restricted spatial region.

Production of electric machines, for example motors, for the most part is achieved with a plurality of production steps. For example, after windings have been drawn in and phase separators, slot insulation and slot seal have been introduced, a stator undergoes an impregnation method, which conventionally is accomplished by means of a hot-curing impregnating resin.

Particularly in the field of smaller motors, frequently an impregnation method is applied in which the motor is drawn through a tank with resin, also referred to as resin tank. In this context, smaller motors are, for example, motors with a shaft height of 63 up to a shaft height of 160, wherein the shaft height is the measurement from motor base to the center of an axis of rotation, in mm.

A subsequent curing in a hot air oven over several hours is energy-intensive, time-consuming and often results in air entrapments and defects in the cured resin.

Larger motors in particular—for example with a shaft height of 180 to a shaft height of 355—with higher requirements are impregnated by means of a method in which the stator is preheated by Joule heating and is subsequently submerged into the resin tank. In the submerged state, the stator is furthermore heated by current, whereby the resin forms gel in the slots and in the winding overhang. The curing subsequently likewise takes place due to the introduction of heat into the winding and shallow drying by means of UV radiation. The stator is heated to a minimum of 150° C. Subsequently, the stator, which often weighs several hundred kilograms, only cools down very slowly over approx. 24 hours, owing to the high thermal capacity. Further work (such as attaching a bearing shield, for example) is only able to take place once it has reached room temperature again, in particular due to coefficients of thermal expansion, which means that either active cooling is necessary or a delay has to be accepted for using the bearing surface at room temperature, owing to the cool-down time.

The object underlying the invention can be considered to be making the production of electric machines more time and energy-efficient.

The object is achieved by claim 1, i.e. a method for impregnating, strengthening or electrically insulating a body supporting single or multi-layer windings, in particular for an electric machine, wherein the body supporting the windings is submerged into a multi-component resin system or is sprinkled with the multi-component resin system or is sprayed with the multi-component resin system.

In the following, this method is also referred to as impregnating method for short.

The object is further achieved by claim 12, i.e. an electric machine, in particular a motor, generator or transformer, is impregnated, strengthened or electrically insulated in accordance with the aforementioned method.

The object is further achieved by claim 13, i.e. a use of a multi-component resin system for impregnating, strengthening or electrically insulating an electric machine.

In an advantageous embodiment of the invention, the body supporting the windings, at room temperature, is submerged into the multi-component resin system or is sprinkled with the multi-component resin system or is sprayed with the multi-component resin system.

Advantageously, the body is a motor or generator or a transformer. The motor/generator advantageously has a rotor and a stator.

The body may also be a stator or a rotor.

In a further advantageous embodiment of the invention, the body supporting the windings, at an ambient temperature of 15 to 25° C., in particular 20 to 23° C., is submerged into the multi-component resin system or is sprinkled with the multi-component resin system or is sprayed with the multi-component resin system.

In a further advantageous embodiment of the invention, the body supporting the windings is preheated to a temperature of 30 to 80° C., in particular 30 to 60° C. Preferably, the body supporting the windings is inductively preheated to a temperature of 30 to 80° C., in particular 30 to 60° C.

This has the advantage that different ambient temperatures, for example in summer or winter, have no influence on the impregnating, strengthening or electrically insulating.

The body supporting the windings, independently of the ambient temperature, has a defined temperature at the beginning of the method for impregnating, strengthening or electrically insulating, and then cools down.

In a further advantageous embodiment of the invention, the multi-component resin system has at least two components, wherein a first component is a resin, wherein a second component is a curing agent.

A first example: The first component, in particular a resin, preferably has a viscosity of 2000 to 2500 mPa·s at an ambient temperature of 25° C. and has a density of 1.13 to 1.17 g/ml at an ambient temperature of 20° C. The second component, in particular a curing agent, preferably has a viscosity of 40 to 60 mPa·s, in particular 50 mPa's, at an ambient temperature of 25° C. and has a density of 0.98 to 1.00 g/ml at an ambient temperature of 20° C. A “parts by weight” mixing ratio advantageously lies at 100 parts resin to 20 parts curing agent. A “parts by volume” mixing ratio advantageously lies at 100 parts resin to 23 parts curing agent. A pot life at room temperature for 100 g of the mixed material advantageously lies between 20 and 40 min, preferably 30 min.

A second example: The first component, in particular a resin, preferably has a viscosity of 2400 to 2600 mPa·s, 2500 mPa·s, at an ambient temperature of 25° C. and has a specific weight of 1.13 to 1.17 g/cm³, in particular 1.15 g/cm³. The second component, in particular a curing agent, preferably has a viscosity of 200 to 200 mPa's, 300 mPa·s, at an ambient temperature of 25° C. and has a specific weight of 1.00 to 1.04 g/cm³, in particular 1.02 g/cm³. A “parts by weight” mixing ratio advantageously lies at 5 parts resin to 1 part curing agent. A “parts by volume” mixing ratio advantageously lies at 4.3 parts resin to 1 part curing agent. The mixed material preferably has a viscosity of 1550 to 1750 mPa·s, 1650 mPa·s, at an ambient temperature of 25° C. and has a specific weight of 1.11 to 1.15 g/cm³, in particular 113 g/cm³. A gel time at 25° C. advantageously lies between 25 and 45 min, preferably 35 min.

The multi-component resin system is preferably highly reactive. The multi-component resin system is preferably a two-component resin system.

Preferably, the second component has a viscosity of 40 to 300 mPa·s at an ambient temperature of 25° C.

In a further advantageous embodiment of the invention, the resin is an epoxy resin, wherein the curing agent is an amine-based curing agent.

The amine-based curing agent brings the advantage that the curing is able to take place at room temperature, also referred to as cold curing. Epoxy resin is advantageous due to its pronounced mechanical properties and only results in a small change in volume during the curing. Epoxy resin advantageously contains no solvent and has VOC<1% (volatile organic compounds), i.e. less than 1% w/w of the overall material evaporates over the course of the curing procedure.

In a further advantageous embodiment, the body rotates about an axis when the body is submerged into a multi-component resin system or is sprinkled with the multi-component resin system or is sprayed with the multi-component resin system.

Advantageously, the body is situated on a rolling station.

In a further advantageous embodiment of the invention, the first component and the second component are conveyed separately from one another, wherein the first component and the second component are mixed to form the multi-component resin system immediately before the submerging or before the sprinkling or before the spraying.

Immediately preferably means at most 10 min.

The rotation of the body prevents the resin system, in particular the resin, from dripping off. Due to capillary forces present, the resin is drawn into the slots, where it sets within a few minutes. A drip-free state should be achieved after at most 20 min. The body can be removed from the rolling station and further processed, without having to cure and/or cool down for a long time.

In a further advantageous embodiment of the invention, the multi-component resin system has a viscosity of 300 mPa·s at 25° C.

This viscosity describes an initial viscosity at 25° C. Since the body has been heated to 30 to 80° C., in particular 30 to 60° C., the actual viscosity is lower.

A viscosity difference that is only low is advantageous when mixing the first and second components. In this context, a dynamic mixing tube allows a greater viscosity difference than a static mixing tube.

In a further advantageous embodiment of the invention, the multi-component resin system has a viscosity of 15000 mPa·s after a period of time of 20 to 30 min after striking the body.

In a further advantageous embodiment of the invention, the multi-component resin system is shaped as a jet with a dosing between 0.2 ml/s and 2 ml/s for the purpose of sprinkling.

The dosing mentioned is advantageous, as the resin system can be conveyed optimally as a result. The dosing mentioned is additionally advantageous, as the resin system can be drawn into the winding optimally via capillary forces as a result.

In a further advantageous embodiment of the invention, the multi-component resin system, at an ambient temperature of 15 to 25° C., in particular 20 to 23° C., is at least 95%, preferably at least 97% cured after less than 100 h, preferably after less than 72 h.

The multi-components resin system preferably cures without the active introduction of heat.

At room temperature, the multi-component resin system is preferably at least 97% cured after 24 h.

The invention offers the advantage that further work (attaching a bearing shield, for example), which only becomes possible at room temperature, due to coefficients of thermal expansion, can be performed soon after the impregnating. No active cooling is required. Furthermore, no delay also has to be accepted for using the bearing surface at room temperature, owing to the cool-down time. Cost and time-efficient manufacturing is thus possible.

The high energy consumption mentioned in the introduction for heating the winding with currents of more than 500 A, for example, is also omitted. To control these currents, very elaborate power electronics are additionally required in a manufacturing installation. These are also omitted due to the invention.

The invention further offers the advantage that, in a manufacturing hall, it is not necessary to provide areas on which the impregnated bodies cool down and cure over what often amounts to several days or even weeks. This results in positive economic effects.

A further advantage of the invention is that it is not necessary to keep resin available in resin tanks, in which there is always the risk of undesired gelling.

It is further conceivable that a three-component resin system is used for impregnating, strengthening or electrically insulating. Additives for thixotropy, preferably on a time-delayed basis, can accelerate a viscosity-increasing effect with regard to a gelling. This results in an increase in a manufacturing efficiency, in particular with regard to a cycle time.

The invention is described and explained in more detail below on the basis of the exemplary embodiments shown in the figures, in which:

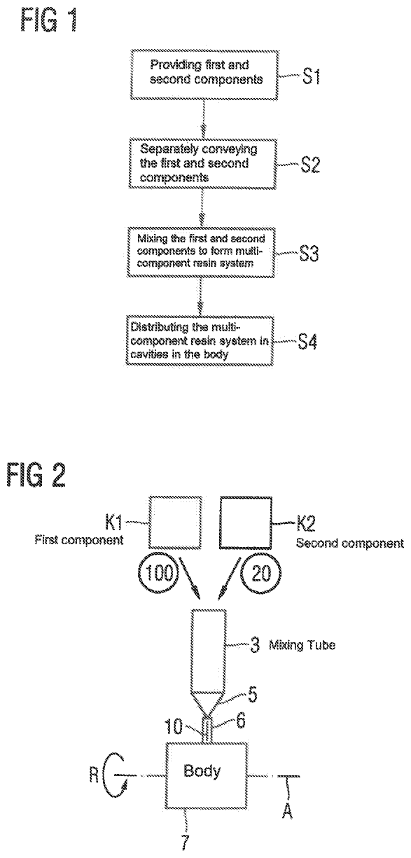

FIG. 1 shows the impregnating method,

FIG. 2 shows an exemplary installation for performing the impregnating method, and

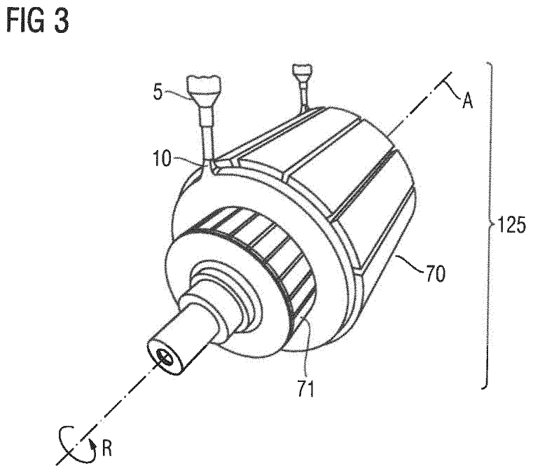

FIG. 3 shows a dynamoelectric rotating machine during the impregnating method.

FIG. 1 shows the impregnating method.

In a first method step, a first component and a second component (reference characters K1 and K2 in FIG. 2) are provided. The first component is preferably a resin, the second component is preferably a curing agent.

The two components are conveyed separately in a method step S2.

In a method step S3, the two components are mixed to form a multi-component resin system (10 in FIG. 2), in this case a two-component resin system, and, preferably immediately after being mixed, are applied to a body (7 in FIG. 2) or introduced into the body.

More than two components are also possible.

In a method step S4, the multi-component resin system is distributed in cavities in the body due to the rotation of the body. If the body is a stator, for example, then the multi-component resin system is distributed into the slots.

FIG. 2 shows an exemplary installation for performing the impregnating method.

The first component K1 and the second component K2 are mixed in the mixing ratio 100:20 indicated by way of example in a mixing tube 3 to form the multi-component resin system 10 and are output as a jet 6 through a nozzle 5 onto the body 7. The body rotates in direction of rotation R about an axis A.

FIG. 3 shows a dynamoelectric rotating machine 12 during the impregnating method. The figure shows a stator 70 and a rotor 71. By way of the nozzle 5, in the figure the multi-component resin system 10 strikes the stator 70, while the stator 70 is rotating in direction of rotation R about the axis A.

During further manufacturing steps, rotor and/or stator are for the most part exposed to increased temperatures. This involves, for example, a winding temperature of approx. 80° C. during the shrink-fitting of the aluminum enclosure at 200° C. and a short-circuit test as the final test with freely selectable heating of the winding. An almost 100% curing of the resin system, where possible at all from a chemical perspective, is ensured before completion.

Without thermal follow-on processes, the curing of the resin system is concluded within a few days. A manufacturing flow is not interrupted, as already after a few minutes there is a drip-free product, the surface of which is not or is only slightly sticky.

The impregnating method offers many advantages: a significant reduction of the energy costs, depending upon material and manufacturing flow it is possible to reduce a cycle time. By omitting the thermal processes, the installation size and area required can be halved.

What is claimed is:

1.-11. (canceled)

12. A method for impregnating, strengthening or electrically insulating a body supporting single or multi-layer windings, in particular for an electric machine, said method comprising:
separately conveying at least a first component of resin and a second component of a curing agent, with the first component having a viscosity of 2400 to 2600 mPa·s at an ambient temperature of 25° C. and a specific weight of 1.13 to 1.17 g/cm³, and with the second component having a viscosity of 200 to 300 mPa·s at an ambient temperature of 25° C. and a specific weight of 1.00 to 1.04 g/cm³;
mixing the first and second components with a “parts by weight” mixing ratio of 5 parts resin to 1 part curing agent and a “parts by volume” mixing ratio lies at 4.3 parts resin to 1 parts curing agent, to form a multi-component resin system with a viscosity of 1550 to 1750 mPa·s at an ambient temperature of 25° C. and a specific weight of 1.11 to 1.15 g/cm³; and
sprinkling the multi-component resin system in a form of a jet with a dosing between 0.2 ml/s and 2 ml/s upon the body at an ambient temperature of 15 to 25° C.

13. The method of claim 12, wherein the multi-component resin system is sprinkled upon the body at an ambient temperature of 20 to 23° C.

14. The method of claim 12, further comprising preheating the body to a temperature of 30 to 80° C.

15. The method of claim 14, wherein the body is preheated inductively.

16. The method of claim 12, wherein the resin is an epoxy resin and the curing agent is an amine-based curing agent.

17. The method of claim 12, further comprising rotating the body about an axis when the body is sprinkled with the multi component resin system.

18. The method of claim 12, wherein the multi-component resin system has a viscosity of 300 mPa·s at 25° C.

19. The method of claim 12, wherein the multi-component resin system has a viscosity of 15000 mPa·s after a period of time of 20 to 30 min after striking the body.

20. The method of claim 12, wherein the multi-component resin system is cured at least 95% at the ambient temperature of 15 to 25° C. after less than 100 h.

21. The method of claim 20, wherein the ambient temperature is 20 to 23° C.

22. The method of claim 20, wherein the multi-component resin system is cured at least 97%.

23. The method of claim 20, wherein the multi-component resin system is cured after less than 72 h.

24. An electric machine, in particular a motor, generator or transformer, said electric machine being impregnated, strengthened or electrically insulated by a method as set forth in claim 12.
